(19) United States
(12) Patent Application Publication
(10) Pub. No.: US 2019/0012821 A1
(43) Pub. Date: Jan. 10, 2019

(54) DISPLAYING IMAGES ASSOCIATED WITH APPS BASED ON APP PROCESSING TASK PROGRESS STATUSES

(71) Applicant: Alibaba Group Holding Limited, George Town (KY)

(72) Inventors: Fan Bu, Beijing (CN); Yuan Xu, Shanghai (CN)

(21) Appl. No.: 16/001,841

(22) Filed: Jun. 6, 2018

(30) Foreign Application Priority Data
Jun. 9, 2017 (CN) 201710434671.2

(51) Int. Cl. G06T 13/80; G06F 3/0481; G06F 8/61; G06F 8/65; G06T 3/00

(52) U.S. Cl. CPC G06T 13/80; G06F 3/04817; G06T 3/0006; G06F 8/65; G06F 8/61

(57) ABSTRACT

Displaying images associated with apps based on app processing task progress statuses is disclosed, including: obtaining a processing task associated with an application (app); obtaining an app image corresponding to the app; determining a first progress status associated with an execution of the processing task associated with the app; displaying a first display of the app image corresponding to the first progress status; determining a second progress status associated with the execution of the processing task associated with the app; and displaying a second display of the app image corresponding to the second progress status, wherein the first progress status is different from the second progress status and wherein the first display of the app image is different from the second display of the app image.

### CROSS REFERENCE TO OTHER APPLICATIONS

This application claims priority to People's Republic of China Patent Application No. 201710434671.2 entitled A METHOD, MEANS, DEVICE, AND STORAGE MEDIUM FOR DISPLAYING ICONS filed Jun. 9, 2017 which is incorporated herein by reference for all purposes.

### FIELD OF THE INVENTION

The present application relates to a field of communication technology. In particular, it relates to techniques for displaying, at a user interface, an image associated with an application (app) corresponding to a progress status of a processing task associated with the app.

### BACKGROUND OF THE INVENTION

As communication technology continues to develop and smart terminals such as smart phones and tablets rapidly become more widespread, the number of applications (apps) available for installation on smart terminals is rapidly increasing. Apps may be used in various contexts including, for example, entertainment, study, and work. Common scenarios involving app use on smart terminals include the downloading and installing of apps.

In some instances, when an app is being downloaded and installed on a smart terminal, text that describes the percentage of the app that has already been downloaded may be displayed on the desktop of the smart terminal. However, this text fails to reflect the app's download progress in an intuitive way. As a result, the user may not be able to intuitively grasp the app's download status by just reading such text.

### BRIEF DESCRIPTION OF THE DRAWINGS

Various embodiments of the invention are disclosed in the following detailed description and the accompanying drawings.

FIG. 1 is a hardware structural diagram of an example smart terminal that displays images associated with apps based on app processing task progress statuses.

FIG. 2 is a hardware structural diagram of another example smart terminal that displays images associated with apps based on app processing task progress statuses.

FIG. 3 is a diagram of an example operating system.

FIG. 4 is a flow diagram showing an embodiment of a process for displaying images associated with apps based on app processing task progress statuses.

FIG. 5 is a flow diagram showing one embodiment of a process for displaying images associated with apps based on app processing task progress statuses.

FIGS. 6(a), (b), (c), and (d) show example displays of varying portions of an app image at a user interface of a smart terminal corresponding to various progress statuses of an execution of a processing task for an app.

FIGS. 7(a), (b), and (c) are diagrams that show examples of displays associated with a process of an app image sliding based on a progress status of an execution of a processing task of an app.

FIG. 8 is a flow diagram showing another embodiment of a process for displaying images associated with apps based on app processing task progress statuses.

FIGS. 9(a), (b), and (c) show example displays of an app image at different sizes at a user interface of a smart terminal corresponding to various progress statuses of an execution of a processing task for an app.

FIG. 10 is a flow diagram showing yet another embodiment of a process for displaying images associated with apps based on app processing task progress statuses.

FIG. 11 is a flow diagram showing an embodiment of a process of displaying images associated with apps based on app processing task progress statuses.

FIG. 12 is a flow diagram showing an embodiment of a process for displaying images associated with apps based on app processing task progress statuses.

FIGS. 13(a), (b), (c), and (d) show example displays associated with displaying an app image in accordance with some embodiments.

FIG. 14 is a flow diagram showing an example of a process for displaying images associated with apps based on app processing task progress statuses.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of a technique for displaying images associated with apps based on app processing task progress statuses are described herein. A processing task associated with an app is obtained. For example, the app is to be executed at a smart terminal, such as, but not limited to, a smart phone, a tablet, an e-reader, an MP3 (Moving Picture Experts Group Audio Layer 3) player, an MP4 (Moving Picture Experts Group Audio Layer 4) player, a laptop computer, a vehicle-mounted computer, a desktop computer, a set-top box, a smart television set, and a wearable device. In various embodiments, a processing task associated with an app comprises a manner in which the app is being processed at the smart terminal. Examples of a processing task may include downloading the app, installing the app, uninstalling the app, loading the app, and updating the app. An app image corresponding to the app is obtained. In various embodiments, an app image comprises an icon or other graphic that is used to represent the app. In some embodiments, once the app image is fully displayed at a user interface (e.g., desktop) of the smart terminal, a user selection of the app image would cause the associated app to execute/open. The app image is displayed based at least in part on a progress status associated with an execution of the processing task of the app. Because the processing task needs time to be completely executed before the app may be available to be accessed by a user, the processing task's progress may be indicated to the user to inform the user of the status of the progress of the app's processing task. For example, a progress status of an execution of an app's processing task indicates the degree to which the execution of the processing task has completed. As such, as described below, the manner in which the app image is displayed is determined based on the current progress status of the app's processing task. Two different progress statuses associated with the execution of the app's processing task will cause the app image to be displayed differently, thereby causing the dynamic graphical appearance of the app image to represent the dynamic progress of the execution of the app's processing task. The dynamic graphical appearance of the app image may cause a user to more intuitively and also better grasp the state of the execution of a processing task for an app, to thereby improve the user's experience of using the smart terminal.

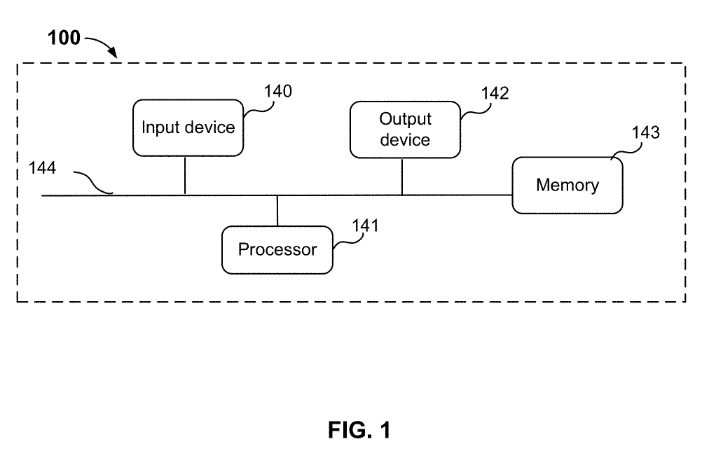

FIG. 1 is a hardware structural diagram of an example smart terminal that displays images associated with apps based on app processing task progress statuses. As shown in FIG. 1, the smart terminal 100 may comprise input device 140, processor 141, output device 142, memory 143, and at least one communication bus 144. Communication bus 144 is for implementing inter-component communication connections. Memory 143 may contain high-speed RAM memory. Memory 143 may also contain non-volatile memory (NVM), such as at least one magnetic disk storage device. Memory 143 may store various programs used to complete various processing functions and instructions to provide to processor 141.

Processor 141 may be implemented as a central processing unit (CPU), an application-specific integrated circuit (ASIC), a digital signal processor (DSP), a digital signal processing device (DSPD), a programmable logic device (PLD), a field-programmable gate array (FPGA), a controller, a microcontroller, a microprocessor, or another electronic component. Processor 141 is coupled to input device 140 and output device 142 through a wired or wireless connection.

Input device 140 may comprise multiple input devices. For example, input device 140 could comprise at least one of the following: a user-oriented user interface, a device-oriented device interface, a software programmable interface, a camera, and a sensor. In some embodiments, the device-oriented device interface may be a wired interface for conducting device-to-device data transmissions, or it could be a hardware insertion interface (e.g., a USB interface or a serial port) for conducting device-to-device data transmissions. In some embodiments, the user-oriented user interface could, for example, be user-oriented control keys, a speech input device for receiving speech input, or a touchscreen perceiving device (such as a touchscreen or a touch tablet having touch-sensing functions). In some embodiments, the programmable interface of the software described above could be a portal, such as a chip input pin interface or output interface, through which the user edits or modifies the program. In some embodiments, the transceiver described above could be a radio-frequency transceiver chip, a baseband chip, or a transceiver antenna. A microphone or other audio input device can receive speech data. Output device 142 may include a display device, sound equipment, and other output devices.

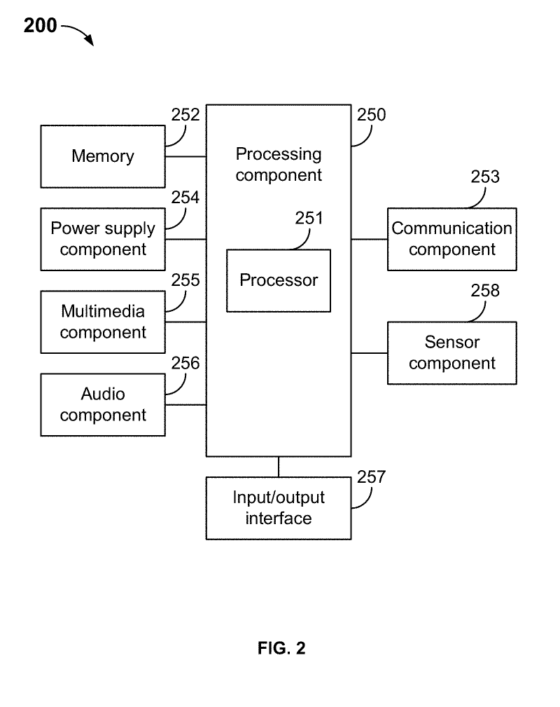

FIG. 2 is a hardware structural diagram of another example smart terminal that displays images associated with apps based on app processing task progress statuses. As shown in FIG. 2, smart terminal 200 comprises processor 251 and memory 252.

The memory 252 is configured to store all kinds of data in support of terminal device operations. Examples of this data include any app or method instructions, such as messages, pictures, and video, used for operations on the terminal device. The memory 252 may contain random access memory (RAM) and may also contain non-volatile memory, such as at least one magnetic disk storage device.

In the example of FIG. 2, the processor 251 is set up in the processing component 250. Smart terminal 200 further comprises communication component 253, power supply component 254, multimedia component 255, audio component 256, input/output interface 257, and sensor component 258. In actual practice, fewer, different, and/or more components may be included in the smart terminal.

Processing component 250 is configured to control the overall operations of smart terminal 200. Processing component 250 comprises one or more instances of processors 251 for executing instructions to display images associated with apps based on app processing task progress statuses. In addition, processing component 250 may comprise one or more modules to facilitate interaction between processing component 250 and other components. For example, processing component 250 may comprise a multimedia module to facilitate interaction between multimedia component 255 and processing component 250.

Power supply component 254 provides electric power to the various components of smart terminal 200. Power supply 254 can include a power supply management system, one or more power supplies, and other components related to generating, managing, and allocating power to smart terminal 200.

Multimedia component 255 comprises an output interface display screen provided between smart terminal 200 and the user. In some embodiments, the display screen may comprise a liquid crystal display (LCD) or a touch panel (TP). If the display screen comprises a touch panel, the display screen may be implemented as a touchscreen to receive input signals from the user. The touch panel comprises one or more touch sensors to detect touches, sliding actions, and gestures on the touch panel. The touch sensor can not only detect the boundaries of touch or slide actions, but also can measure duration and pressure related to the touch or slide operations.

Audio component 256 is configured to output and/or input audio signals. For example, audio component 256 includes a microphone (MIC). When smart terminal 200 is in an operating mode, e.g., speech recognition mode, the microphone is configured to receive external audio signals. The received audio signals can be further stored in storage device 252 or sent by communication component 253. In some embodiments, audio component 256 further comprises a speaker for output of audio signals.

Input/output interface 257 provides an interface between processing component 250 and peripheral interface modules. The peripheral interface modules may include keyboards, click wheels, buttons, etc. These buttons may include but are not limited to: volume button, start button, and lock button.

Sensor component 258 comprises one or more sensors and is used to provide status evaluations of various aspects of smart terminal 200. For example, sensor component 258 may detect the on/off status of smart terminal 200, the relative position of the component, and the presence or absence of contact between the user and smart terminal 200. Sensor component 258 may comprise a near sensor that is configured to detect the presence of a nearby object when there is no physical contact, including the measurement of distance between the user and smart terminal 200. In some embodiments, sensor component 258 may further comprise a camera.

Communication component 253 is configured to facilitate wired or wireless communication between smart terminal 200 and other devices. Smart terminal 200 may access wireless networks based on a communications standard such as WiFi, 2G, 3G, or combinations thereof. In an embodiment, smart terminal 200 may comprise a SIM card slot. The SIM card slot is for inserting a SIM card, which enables smart terminal 200 to register with a GPRS network and establish communication between the Internet and servers.

For example, communication component 253, audio component 256, input/output interface 257, and sensor component 258 of smart terminal 200 may serve as an implementation of input device 140 in smart terminal 100 that is illustrated in FIG. 1.

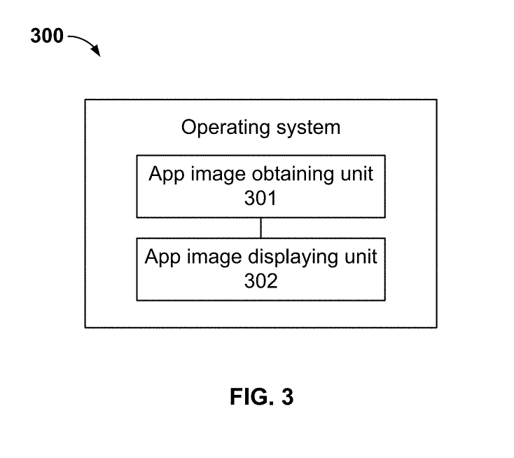

FIG. 3 is a diagram of an example operating system. In the example of FIG. 3, operating system 300 includes app image obtaining module 301 and app image displaying module 302. In some embodiments, operating system 300 may be implemented at smart terminal 100 of FIG. 1 and/or smart terminal 200 of FIG. 2.

App image obtaining module 301 is configured to obtain an image associated with an app. In various embodiments, the app image comprises an icon that is provided by a developer or other source (e.g., an app store or database for storing app images) from which the app is obtained. After the app is downloaded and fully installed on the smart terminal, its app image (e.g., icon) is displayed in its entirety at a user interface (e.g., desktop) of the smart terminal. The app image may be selected by a user to cause the corresponding app to execute at the smart terminal.

App image displaying module 302 is configured to display the app image based at least in part on a progress status associated with an execution of a processing task associated with the app. A first display of the app image corresponding to a first progress status associated with an execution of the processing task associated with the app is different from a second display of the app image corresponding to a second progress status associated with the execution of the processing task associated with the app. For example, a processing task associated with the app comprises one of downloading the app, installing the app, uninstalling the app, loading the app, and updating the app. The execution of a processing task takes time so its progress is dynamic. The current progress status of the execution of a processing task of an app is indicated by app image displaying module 302 dynamically altering the appearance of and/or the manner in which the app image is displayed at the user interface of the smart terminal to provide a graphical indication to the user of how far along the execution of the app's processing task is. As will be described in further detail below, as the progress of the execution of an app's processing task dynamically changes (e.g., increases), app image displaying module 302 changes the manner in which the app image is displayed so as to visually indicate the degree to which the processing task is nearing completion.

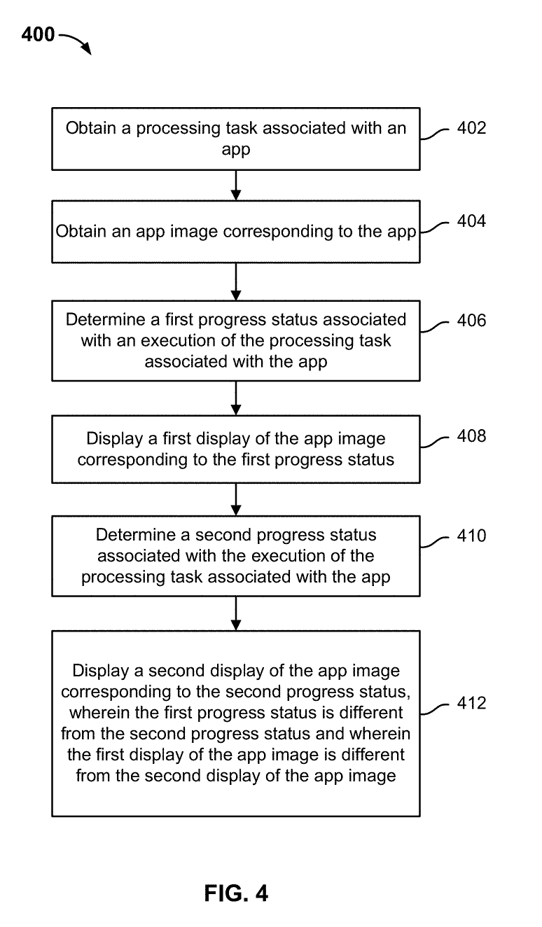

FIG. 4 is a flow diagram showing an embodiment of a process for displaying images associated with apps based on app processing task progress statuses. In some embodiments, process 400 is implemented at smart terminal 100 of FIG. 1, smart terminal 200 of FIG. 2, and/or at operating system 300 of FIG. 3.

At 402, a processing task associated with an app is obtained. In various embodiments, an “app” comprises a computer program that is configured to run on a smart terminal. Apps may be configured for use in various areas, including, for example, entertainment, productivity, shopping, social media, navigation, communication, traveling, etc. In various embodiments, a processing task associated with an app may relate to the downloading of the app, the installation of the app, the uninstallation of the app, and the updating of the app.

In a first example, the processing task of downloading an app may be generated in response to a user input/selection to download an app from an app download portal. For example, the app download portal may be provided by an app management program such as an app center or an app store.

In a second example, the processing task of installing an app may be generated in response to a user input/selection to install the app. For example, the app's installation package was obtained during the downloading of the app. The app installation portal could be provided by an app management program such as an app center. Or the app installation package could directly serve as the app installation portal. The present application imposes no restrictions concerning particular app installation portals.

In a third example, the processing task of uninstalling an app may be generated in response to a user input/selection to uninstall the app.

In a fourth example, the processing task of updating an app may be generated in response to a user input/selection to update the app. For example, an app management program may indicate that an update is available for a particular app and in response, a user may select a control to generate a processing task to update that app.

In some embodiments, information associated with processing tasks associated with one or more apps may be written to a cache at the smart terminal. In some embodiments, the processing tasks may be stored in the cache in the order/sequence in which user selections to generate the processing tasks are received at the smart terminal. As such, a processing task corresponding to an app may be fetched from the cache and executed. In some embodiments, the cache for storing processing tasks corresponding to apps may comprise a data structure such as, for example, a queue, an array, or a link list that is established in the memory of a smart terminal. The use of a cache to store apps in need of processing as described above can improve app processing efficiency because data is quickly accessible from memory. In some embodiments, the cache is stored in a magnetic disk storage in a smart terminal. Embodiments of the present application impose no restrictions as to the specific cache and/or the storage medium in which it is implemented.

In some embodiments, information associated with each processing task may comprise, but is not limited to, one or more of the following: a name of the app or name of the installation package corresponding to the app (hereinafter referred to as “package name”), the address from which the app was downloaded, the time at which the app was downloaded or installed, the app package name, the storage address, and other such information. Embodiments of the present application impose no restrictions as to information of the downloading tasks or installation tasks described above.

In some embodiments, the cache that is used to store information associated with processing tasks could be implemented as a queue that employs the first-in, first-out (FIFO) scheme. For example, where a cache uses the FIFO scheme, processing tasks for which information is stored in the cache are processed in the chronological sequence in which their information was written to the cache.

At 404, an app image corresponding to the app is obtained. Various different approaches may be used to obtain an app image corresponding to an app. For example, an app image may comprise an “app icon.” In various embodiments, the obtained app image comprises the full image or the original image that represents the app. In some embodiments, a mapping relationships table between predetermined apps and app images may be pre-established and stored. As such, the app image corresponding to an app may be obtained by querying such a mapping relationships table. For example, the predetermined apps could be all or some apps included in the app center. In another example, the predetermined apps could include those apps whose download frequency or use frequency is higher than a frequency threshold value. In some embodiments, the app images stored in the mapping relationship table could be the original app images that are provided by the server corresponding to the app center (e.g., app store) or they could be app icons (e.g., reduced-size images) obtained following preprocessing of original app images. For example, preprocessing of original app images could be based on the characteristics of the smart terminal operating system. Examples of the preprocessing could include at least one of the following: image shrinking/expansion, image corner rounding, and addition of background masks. Embodiments of the present application impose no restrictions as to the particular preprocessing of original app images.

In some embodiments, an app image request could be sent to a server, and this app image request may include the name or package name of the app. The server would then return an app image based on the request. The server could be a server computer corresponding to an app center, or it could be a third party server computer, for example. This third party server could provide adapted app images based on the operating system characteristics of the smart terminal.

At 406, a first progress status associated with an execution of the processing task associated with the app is determined.

At 408, a first display of the app image corresponding to the first progress status is displayed.

At 410, a second progress status associated with an execution of the processing task associated with the app is determined.

At 412, a second display of the app image corresponding to the second progress status is displayed, wherein the first progress status is different from the second progress status and wherein the first display of the app image is different from the second display of the app image.

The progress status of the execution of a processing task of an app may be determined based on various techniques and/or based on the type of the processing task.

One example technique of determining the current progress status of the execution of the processing task of downloading an app is reading the amount of app data that has already been downloaded into a local folder for downloaded content at the smart terminal and then comparing the amount of data to the total volume of data for that app to obtain a proportion or percentage of download completion. As more app data is downloaded, the progress status of the downloading task changes. Another example technique of determining the current progress status of the execution of the processing task of downloading an app is querying the app center program of the smart terminal for a download progress and then transmitting this progress to the desktop program of the smart terminal. As will be described in further detail below, the display/appearance of the corresponding obtained app image is continually/dynamically updated in response to the dynamically changing progress status of the execution of the processing task of downloading an app.

One example technique of determining the current progress status of the execution of the processing task of installing an app is determining the total size of the files in the installation package that need to be installed, determining the size of the app installation package files that have been installed successfully, and using the ratio of the size of the app installation package files that have been installed successfully to the total size as the current installation progress. As will be described in further detail below, the display/appearance of the corresponding obtained app image is continually/dynamically updated in response to the dynamically changing progress status of the execution of the processing task of installing an app.

In some embodiments, the app image of an app for which a processing task is still being executed may be displayed with a transparency value that is different from the transparency value with which the app image will be displayed once the execution of the processing task has completed. For example, for the processing task of installing an app, the app image corresponding to the app could be displayed at the desktop user interface of the smart terminal using a first preset transparency value as the app is still being installed (e.g., the progress status of the processing task is less than complete or 100%). This first preset transparency value is different from the transparency value (hereinafter referred to as the “second preset transparency value”) with which app images of already installed apps are displayed on the desktop user interface of the smart terminal. For example, the range of a transparency value is [0, 1], where 1 indicates total transparency and 0 indicates total non-transparency (i.e., opaque). For example, the second preset transparency value is 0, in which case the first preset transparency value would be a positive real number greater than 0 and less than or equal to 1, such as 0.5, for example. As such, the app image of an app that is still being installed may be displayed in a less than completely opaque manner while the app image of the app, after it's completely installed, may be displayed in a completely opaque manner at the desktop user interface. Embodiments of the present application impose no restrictions on the particular first preset transparency value.

Embodiments of the present application do not impose restrictions on the particular techniques by which the current progress status of an execution of a processing task of an app is determined.

Determining the current progress status of the execution of processing tasks such as uninstalling an app, loading an app, and updating an app may be performed using similar techniques to those described for the processing tasks of downloading an app and installing an app.

As will be described in further detail below, the display of an app image corresponding to an app for which a processing task is being executed is dynamically updated based on the current progress status of the execution of the processing task. Because the execution of a processing task takes time to complete, the progress status of the execution of the processing task is dynamic and as a result, so is the display of the app image. By dynamically modifying the appearance of the app image, the app image is used as a visual representation of the current progress status of the execution of an app's processing task.

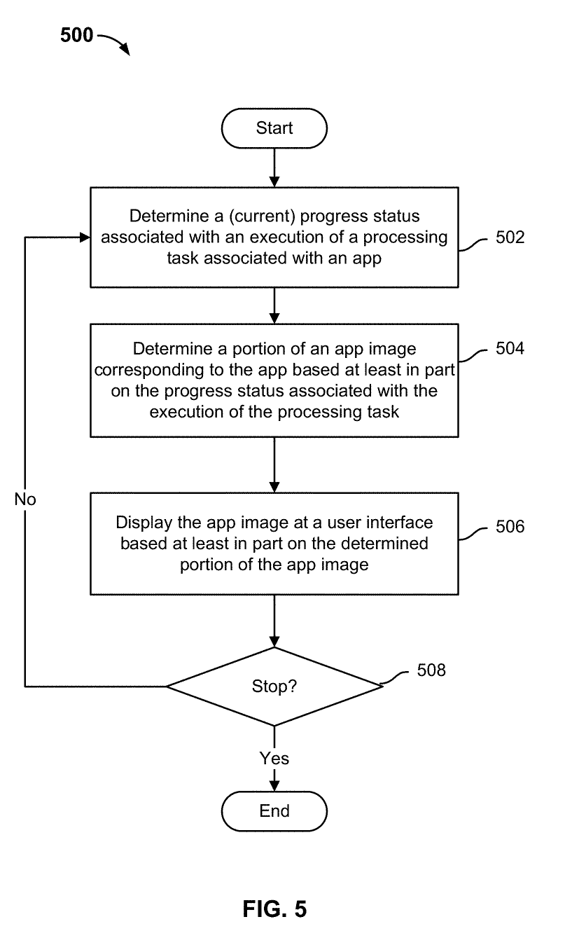

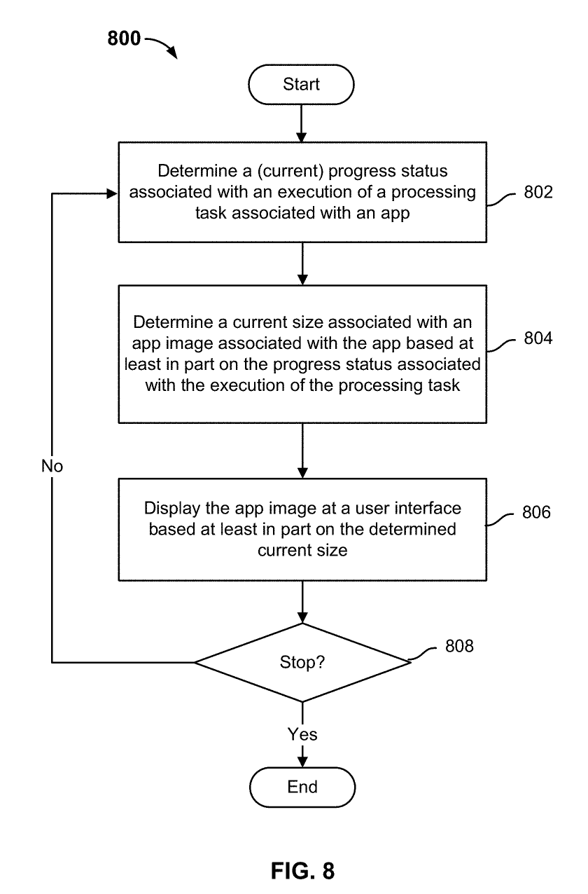

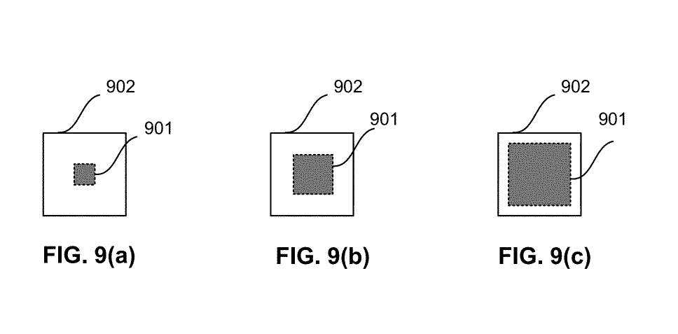

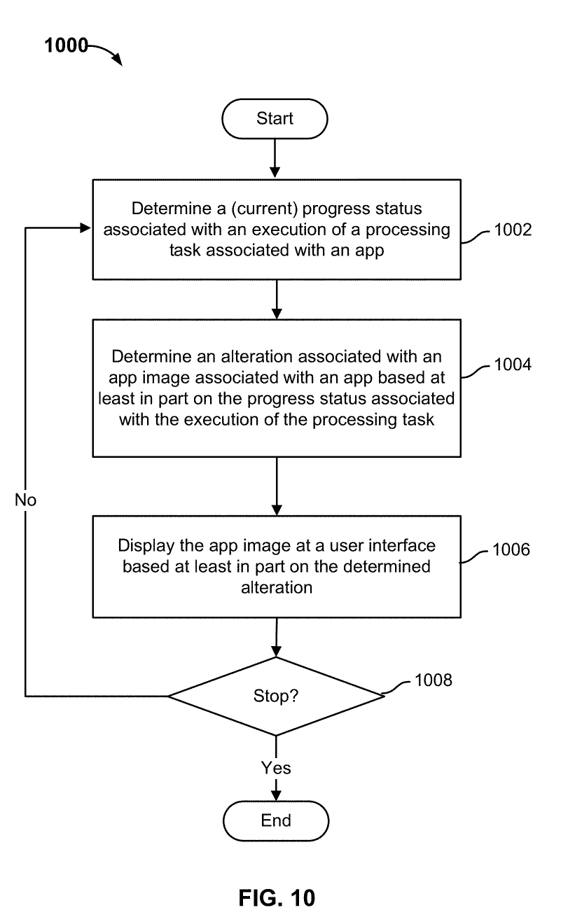

FIGS. 5 through 7 describe one embodiment of displaying the app image based on a progress status of an execution of a processing task for an app. FIGS. 8 through 9 describe another embodiment of displaying the app image based on a progress status of an execution of a processing task for an app. FIG. 10 describes yet another embodiment of displaying the app image based on a progress status of an execution of a processing task for an app.

FIG. 5 is a flow diagram showing one embodiment of a process for displaying images associated with apps based on app processing task progress statuses. In some embodiments, process 400 of FIG. 4 is implemented at least in part using process 500. In some embodiments, process 500 may be implemented at smart terminal 100 of FIG. 1, smart terminal 200 of FIG. 2, and/or operating system 300 of FIG. 3.

Process 500 describes an example of displaying app images associated with apps based on app processing task progress statuses in which a portion of an app image of an app is determined and displayed based on a determination of the current execution progress of a processing task for that app. As shown below, steps 502, 504, and 506 may be periodically repeated until the progress status corresponding to an execution of a processing task indicates that the execution has completed (e.g., reached 100%).

At 502, a (current) progress status associated with an execution of a processing task associated with an app is determined. The progress status that includes the current degree to which a processing task associated with an app has been executed is determined. In some embodiments, the progress status of the execution of a processing task comprises a percentage or some other value that represents the current degree to which a processing task associated with an app has been executed.

At 504, a portion of an app image corresponding to the app is determined based at least in part on the progress status corresponding to the execution of the processing task. A portion of the app image (e.g., icon) is determined based on the determined progress status.

At 506, the app image is displayed at a user interface based at least in part on the determined portion of the app image.

At 508, it is determined if a stop criterion has been met. In some embodiments, it is determined whether the progress status has met a predetermined completion condition (e.g., 100%). In the event that the stop criterion has been met, process 500 ends. Otherwise, in the event that the stop criterion has not been met, control is returned to 502.

The process of gradually increasing the amount of the app image that is displayed at a user interface in correspondence to the gradually increasing progress of the execution of an app's processing task as described by process 500 enables a user to intuitively grasp the changing state of the app's processing task.

In some embodiments, mapping relationships between progress statuses and corresponding portions of the app image that are to be displayed at a user interface (e.g., a desktop) of the smart terminal are pre-established. Therefore, for a given determined progress status, the corresponding portion of the app image that is to be displayed at the user interface is looked up in the pre-established mappings. For example, the pre-established mappings may dictate which percentages of the app image to display at the user interface for a given percentage or range of percentage completion of the execution of the processing task.

In some embodiments, a predetermined rule that dictates a percentage of the app image to display at the user interface for a given percentage completion of the execution of the processing task may be used to determine which portion of the app image to display at the user interface. For example, the predetermined rule could be a function in which the argument, x, of the function, f1(x), is the current percentage completion of the execution of the processing task to determine output, y1, which dictates the portion (e.g., percentage) of the app image that is to be displayed at the user interface (i.e., y1=f1(x), wherein x is the current processing progress status, y1 is the current portion of the app image that is to be displayed, and x and y1 can both have the range of [0,1]). For example, function f1(x) may dictate that as the progress status of the execution of the processing task increases (e.g., as a greater percentage of the processing task is completed), the more the app image is displayed at the user interface. For example, f1(x) may dictate that the same percent of the app image is to be displayed at the user interface for the given percentage completion of the processing task.

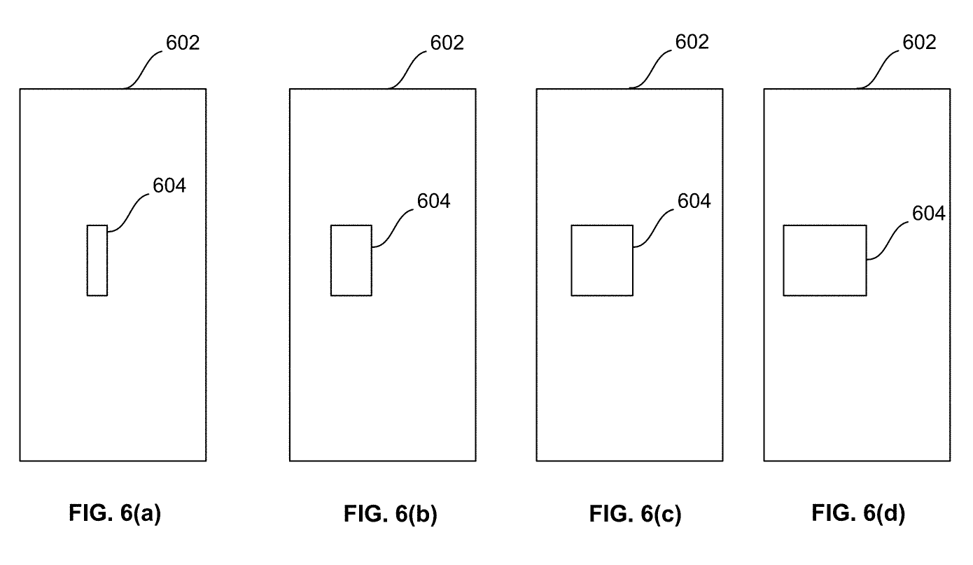

FIGS. 6(a), (b), (c), and (d) show example displays of varying portions of an app image at a user interface of a smart terminal corresponding to various progress statuses of an execution of a processing task for an app. In some embodiments, process 500 of FIG. 5 may be used to implement the example displays as shown in FIGS. 6(a), (b), (c), and (d). As described in process 500 of FIG. 5, a portion of an app image that is displayed at a user interface may dynamically vary as the execution of a processing task for the corresponding app progresses. In FIGS. 6(a), (b), (c), and (d), user interface 602 may comprise a desktop at a smart terminal and more and more of an app image (e.g., icon) 604 is presented at user interface 602 as the progress status indicates that more of the processing task is completed. Specifically, the progress statuses corresponding to FIGS. 6(a), (b), (c), and (d) may correspond to respective displays of 25%, 50%, 75%, and 100% of app image 604 respectively. The displays of various percentage portions of the app image as shown in FIGS. 6(a), (b), (c), and (d) are merely examples. In actual practice, portions of the app image that are displayed corresponding to different progress statuses of the execution of a processing task for an app may vary based on different needs.

In some embodiments, to display the app image based at least in part on the determined portion of the app image comprises to extract some part of the full app image, where the extracted part of the app image is displayed at the user interface of the smart terminal and the portion of the full app image that is not extracted is not displayed (e.g., is hidden from view) at the user interface. Which portion and how much of the app image is extracted depends on the determined current progress status of the processing status. In some embodiments, the extracting of the app image is performed according to a preset direction based on determined current progress status. An extracting tool program can extract portions of the app image from a preset direction. It is possible to extract/display less than or all of an app image. For example, a preset direction may comprise: left-to-right, right-to-left, top-to-bottom, bottom-to-top, etc. To take the example of the left-to-right direction, increasingly larger portions of the app image starting from the left side can be extracted/retained for display at the user interface, while the remaining portion of the app image on the right side can be hidden from view at the user interface. For example, if it is determined that 25% of the app image is to be displayed at the user interface, then the 25% of the app image starting from its left side may be extracted and then displayed at the user interface while the remaining 75% of the app image to the right of the extracted portion is hidden/not displayed at the user interface. To take another example of the top-to-bottom as an example, increasingly larger portions of the app image starting from the top can be extracted/retained for display at the user interface, while the remaining portion of the app image below the extracted portion can be hidden from view at the user interface.

In some embodiments, the portion of the app image that is to be displayed as determined by the progress status of the execution is animated to slide into a target zone at the user interface. In some embodiments, the “target zone” comprises an area of the user interface within which different portions of the app image will be displayed during the execution of a processing task for the app and within which the full app image will be displayed after the completion of the execution of the processing task. Put another way, as the execution of the processing task for an app progresses further, more of the app image could be animated to gradually slide into the target zone corresponding to the app at the user interface. The target zone may represent the sliding zone range of the app image. The target zone could provide a zone and background for the app image. For example, the user interface at which the app image is displayed is a desktop program of a smart terminal. Thus, adapted to the operating system characteristics, a desktop area generally can comprise multiple app image (e.g., icon) positions, each of which is for displaying one image/icon. Therefore, the process of acquiring a target zone corresponding to the app from the interface may include acquiring a blank icon position from among the positions that are included in the desktop area and making the zone corresponding to this blank icon position the target zone for the app image of a particular app for which a processing task is to be performed.

In some embodiments, a target zone for the app image of a particular app for which a processing task is to be performed could be decided according to a sequencing rule for icon positions. Examples of sequencing rules could be: upper left (from left to right, from top to bottom of the desktop area) or lower left (from left to right, from bottom to top of the desktop area). Thus, the search for the target zone for a particular app could proceed according to an upper-left or a lower-left direction. In some embodiments, with regard to the upper-left approach, the icon positions adjacent to and to the left and/or above the blank icon could be non-blank. In this way, the icon position utilization ratio can be increased. In some embodiments, the zone corresponding to the icon position and the target zone could be rectangular in shape (although other shapes may be used as well).

In some embodiments, a target zone comprises a back panel. This back panel can be used to include the at least portion of the app image that is to be displayed. In some embodiments, each icon at a user interface of the smart terminal is displayed as a combination (e.g., stack) of one or more display layers. The following is an example of a top-to-bottom order of three display layers that are associated with an app image: a first display layer corresponding to the app icon, a second display layer corresponding to the back panel, and a third display layer corresponding to the background or wallpaper. Thus, the second display layer corresponding to the back panel could be located between the third display layer corresponding to the background and the first display layer corresponding to the app icon. In some embodiments, the second display layer may also be used to include the first display layer. In some embodiments, the content of the back panel could be background content (wallpaper content) that has been blurred. This can improve the recognizability of the app icon displayed on the back panel. Examples of blurring might include Gaussian blurring or surface blurring. Embodiments of the present application impose no restrictions as to the particular shapes or contents of the target zones described herein.

In some embodiments, to display the app image in the target zone based at least in part on the determined portion of the app image comprises to display that portion of the app image that is to be displayed as sliding within the target zone associated with the app and hiding the remaining portion of the app image that is located outside of the target zone. Hiding the remaining portion of the app image that is outside of the target zone causes the portion of the app image that is within the target zone to exhibit a gradual increasing trend, which parallels the gradual increasing progress of the execution of the processing task. In some embodiments, the current progress status of the execution of the processing task for an app can be repeatedly/dynamically determined to obtain the real-time current processing progress status. The portion of the app image that is to be displayed in (having been shown as sliding into) the target zone may be obtained by dynamically trimming the full app image or cutting some part of the full app image, where the cut part of the app image is displayed at the user interface of the smart terminal covering the full app image, for example. The trimming approach may include cropping out the portion of the app image that is to be located outside of the target zone in real time according to the current processing progress status. The covering approach may include using content of the desktop located just outside of the target zone to cover the portion of the app image that is located outside of the target zone in real-time according to the current processing progress status. Embodiments of the present application do not impose restrictions as to the particular techniques by which the portion of the app image that is displayed within the target zone is obtained.

In some embodiments, the position within the user interface (e.g., desktop) of the smart terminal at which to display the “sliding” app image is determined based on the current progress status of the execution of the processing task of the app. For example, the current position of the app image can be determined from the app image's initial position and sliding distance of the app image. Also, for example, the slide distance can be determined according to the current processing progress status of the processing task. For example, the current position of the app image could be the result of adding the initial position of the app image to the sliding distance. For example, the sliding distance could be the product of the difference between the final position of the app image and the initial position of the app image, and the current processing progress status. That is, the relationship between the current position of the app image and the current processing progress status can be expressed as:

Current position of app image=Initial position of app image+(Final position of app image−Initial position of app image)×Current processing progress status.

As such, the sliding result of the app image is displayed on the desktop according to the current position of the app image. The processing progress here has a range of [0,1], for example.

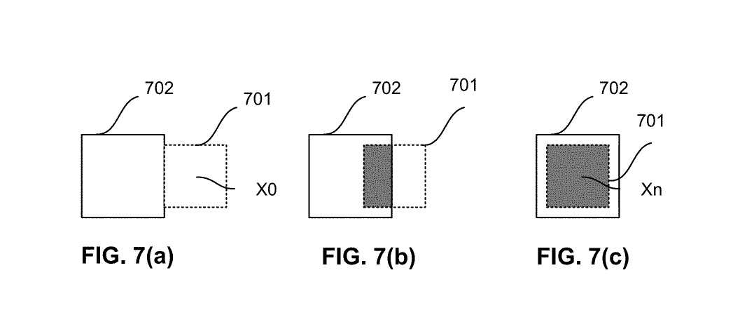

FIGS. 7(a), (b), and (c) are diagrams that show examples of displays associated with a process of an app image sliding based on a progress status of an execution of a processing task of an app. In some embodiments, process 500 of FIG. 5 may be used to implement the example displays as shown in FIGS. 7(a), (b), and (c). In the examples of FIGS. 7(a), (b), and (c), app image 701 is being shown to slide from right to left within target zone 702. Assume that the current position of app image 701 is expressed by the horizontal coordinate of the center position of app image 701. FIG. 7(a) shows the initial state of app image 701 sliding process (i.e., prior to app image 701 sliding into target zone 702), in which the left edge of app image 701 overlaps with the right edge of target zone 702. For example, the difference between the horizontal coordinate X0 of the initial center position of app image 701 and the horizontal coordinate of the right edge of the target zone 702 can be ½ of app image 701's width. FIG. 7(c) shows the final state of the sliding process in which app image 701 has slid entirely into target zone 702 and is located at a default position of being in the center. In the final state of the sliding process as shown in FIG. 7(c), the center position Xn in app image 701 can overlap with the center position of target zone 702. FIG. 7(b) shows the sliding process in an intermediate state between its initial state and the final state. As shown in FIGS. 7(a), (b), and (c), the portions of app image 701 that have entered target zone 702 and that have been shaded in are displayed at the user interface whereas the portions of app image 701 that are located outside of target zone 702 are not displayed (e.g., hidden from view) at the user interface.

While FIGS. 7(a), (b), and (c) show a sliding process in which the app image slides into the target zone from the right-to-left direction, in actual practice, the sliding process may proceed in other directions (e.g., bottom-to-top, left-to-right, top-to-bottom) relative to the target zone as well. Embodiments of the present application impose no restrictions as to the specific sliding direction of the app image relative to the target zone.

FIG. 8 is a flow diagram showing another embodiment of a process for displaying images associated with apps based on app processing task progress statuses. In some embodiments, process 400 of FIG. 4 is implemented at least in part using process 800. In some embodiments, process 800 may be implemented at smart terminal 100 of FIG. 1, smart terminal 200 of FIG. 2, and/or operating system 300 of FIG. 3.

Process 800 describes an example of displaying app images associated with apps based on app processing task progress statuses in which a size at which to display an app image of an app is determined based on a determination of the current execution of a processing task for that app and the app image is displayed based on the determined size. As shown below, steps 802, 804, and 806 may be periodically repeated until the progress status corresponding to an execution of a processing task indicates that the execution has completed (e.g., reached 100%).

At 802, a (current) progress status associated with an execution of a processing task associated with an app is determined. The progress status that includes the current degree to which a processing task associated with an app has been executed is determined. In some embodiments, the progress status of the execution of a processing task comprises a percentage or some other value that represents the current degree to which a processing task associated with an app has been executed.

At 804, a current size associated with an app image associated with the app is determined based at least in part on the progress status associated with the execution of the processing task.

At 806, the app image associated with the app is displayed at a user interface based at least in part on the current size.

At 808, it is determined if a stop criterion has been met. In some embodiments, it is determined whether the progress status has met a predetermined completion condition (e.g., 100%). In the event that the stop criterion has been met, process 800 ends. Otherwise, in the event that the stop criterion has not been met, control is returned to 802.

The process of gradually changing (e.g., by shrinking or expanding) the size of the app image that is displayed at a user interface in correspondence to the gradually increasing progress of the execution of an app's processing task as described by process 800 enables a user to intuitively grasp the changing state of the app's processing task.

In some embodiments, mapping relationships between progress statuses and corresponding sizes at which the app image is to be displayed at a user interface (e.g., a desktop) of the smart terminal are pre-established. Therefore, for a given determined progress status, the corresponding size of the app image that is to be displayed at the user interface is looked up in the pre-established mappings.

In some embodiments, a predetermined rule that dictates a size at which to display the app image at the user interface for a given percentage completion of the execution of the processing task may be used to determine how much to shrink or expand the app image at the user interface. For example, the predetermined rule could be a function in which the argument, x, of the function, f2(x), is the current percentage completion of the execution of the processing task to determine output, y2, which dictates the updated size of the app image that is to be displayed at the user interface (i.e., y2=f2(x), wherein x is the current processing progress status, y2 is the current size at which the app image is to be displayed, and x is the range of [0,1] and y2 may have any appropriate range (e.g., a range that spans the minimum to maximum size of an app image)). For example, function f2(x) may dictate that as the progress status of the execution of the processing task increases (e.g., as a greater percentage of the processing task is completed), the greater the size at which the app image is displayed at the user interface.

In some embodiments, the app image may gradually expand or shrink within a target zone in a user interface in correspondence to the changing progress status of the execution of an app's processing task. In some embodiments, the “target zone” comprises an area of the user interface within which the app image may be displayed at different sizes during the execution of a processing task for the app. The target zone may therefore provide an area of the user interface for displaying the app image and also an area of the user interface that serves as a background for the app image.

In some embodiments, the current size of the app image that is determined in correspondence to the changing progress status of the execution of the app's processing task is a function of the initial size of the app image and/or its previous size, which was determined based on the previous progress status of the execution of the app's processing task. For example, the initial size of the app image may occupy a relatively small area of the target zone so that the current size of the app image may increase as the progress status increases in value. In some embodiments, the app image is displayed at each current size within the target zone by altering/modifying/scaling the final app image dimensions. For example, the current size of the app image can be the result of adding the initial size of the app image to the expansion size. The expansion size could be the product of the difference between the final size of the app image and the initial size, and the processing progress status. That is, the relationship between the current size of the app image and the processing progress status can be expressed as:

Current size of app image=Initial size of app image+(Final size of app image−Initial size of app image)×Current percentage completion.

The processing progress here has a range of [0,1]. Assuming that the initial size of the app image is small relative to the area of the target zone, the size of the app image may thus be gradually expanded to fill the target zone by gradually updating the current size of the app image.

FIGS. 9(a), (b), and (c) show example displays of an app image at different sizes at a user interface of a smart terminal corresponding to various progress statuses of an execution of a processing task for an app. Specifically, FIGS. 9(a), (b), and (c) show example displays of gradually expanding the size of an app image at the user interface. In some embodiments, process 800 of FIG. 8 may be used to implement the example displays as shown in FIGS. 9(a), (b), and (c). FIGS. 9(a), (b), and (c) show the relative sizes of app image 901 and target zone 902 in the initial state, its intermediate state, and its final state in the gradual size expansion process, respectively. During the process of gradually expanding app image 901, the center position of app image 901 may remain fixed at the center of target zone 902, while the size of app image 901 changes. The final size of app image 901 as shown in FIG. 9(c) at the completion of the processing task (e.g., the completed download or completed installing of an app) may be the default or original size of app image 901. The initial size of app image 901 as shown in FIG. 9(a) is smaller than the final size of app image 901 as shown in FIG. 9(c). For example, the ratio of the initial size of app image 901 to the final size of app image 901 could be between 10% and 20%. Embodiments of the present application impose no restrictions on the initial size of the app image.

While FIGS. 9(a), (b), and (c) show an app image being displayed at gradually increasing (expanding) sizes, in some instances, the app image may be displayed at gradually decreasing (shrinking) sizes. For example, the app image being displayed in the examples provided by FIGS. 9(a), (b), and (c) may represent an app for which a processing task of downloading the app, installing the app, or updating the app is being executed. In other examples in which a processing task of uninstalling the app is being executed, the app image may be shown to shrink from an initial size down to a final size that is smaller than the initial size within the target zone to represent that the app is gradually being uninstalled.

FIG. 10 is a flow diagram showing yet another embodiment of a process for displaying images associated with apps based on app processing task progress statuses. In some embodiments, process 400 of FIG. 4 is implemented at least in part using process 1000. In some embodiments, process 1000 may be implemented at smart terminal 100 of FIG. 1, smart terminal 200 of FIG. 2, and/or operating system 300 of FIG. 3.

Process 1000 describes an example of displaying app images associated with apps based on app processing task progress statuses in which the appearance of an app image of an app is altered based on a determination of the current execution of a processing task for that app and the altered app image is displayed. As shown below, steps 1002, 1004, and 1006 may be periodically repeated until the progress status corresponding to an execution of a processing task indicates that the execution has completed (e.g., reached 100%).

At 1002, a (current) progress status associated with an execution of a processing task associated with an app is determined. The progress status that includes the current degree to which a processing task associated with an app has been executed is determined. In some embodiments, the progress status of the execution of a processing task comprises a percentage or some other value that represents the current degree to which a processing task associated with an app has been executed.

At 1004, an alteration associated with an app image associated with the app is determined based at least in part on the progress status associated with the execution of the processing task.

At 1006, the app image is displayed at a user interface based at least in part on the alteration.

At 1008, it is determined if a stop criterion has been met. In some embodiments, it is determined whether the progress status has met a predetermined completion condition (e.g., 100%). In the event that the stop criterion has been met, process 1000 ends. Otherwise, in the event that the stop criterion has not been met, control is returned to 1002.

The process of gradually altering the appearance of the app image that is displayed at a user interface in correspondence to the gradually increasing progress of the execution of an app's processing task as described by process 1000 enables a user to intuitively grasp the changing state of the app's processing task.

In some embodiments, altering the appearance of the app image includes one or more of, but not limited to, the following: flipping the app image, revolving the app image, and stretching the app image. For example, revolving the app image may include transforming one or more page elements in any angle on the plane of the screen of the smart terminal. Flipping may include rotating the app image about any axis perpendicular to the plane of the screen of the smart terminal. Stretching may include shrinking or expanding the app image to a non-fixed length-to-width ratio. Other forms of altering the app image may be employed as appropriate and embodiments of the present application do not impose any restriction as to the manner in which the app image is to be altered in correspondence to the progress status of the execution of the processing task of an app. In some embodiments, altering of the app image may be performed by calling one or more Application Programming Interfaces (APIs) that are provided by the operating system.

In various embodiments, any type of alteration that is performed on the app image is performed proportional to the current progress status of the execution of the processing task of the app. For example, the greater the progress status, the greater the alteration that is performed on the app image. In a specific example, the greater the progress status, the more the app image may be altered to deviate from its original appearance.

In some embodiments, the degree to which the app image is altered may be determined as a function of the current progress status and a preset coefficient. This preset coefficient may be determined according to actual application need by persons skilled in the art. For example, if the shape-altering is flipping, the flipping angle range could be [−30°, 30°], in which case the preset coefficient could be determined according to this range. Embodiments of the present application impose no restrictions as to the specific preset coefficient.

Embodiments of displaying images associated with apps based on app processing task progress statuses as described by process 500 of FIG. 5, process 800 of FIG. 8, and process 1000 of FIG. 10 may be performed individually or combined.

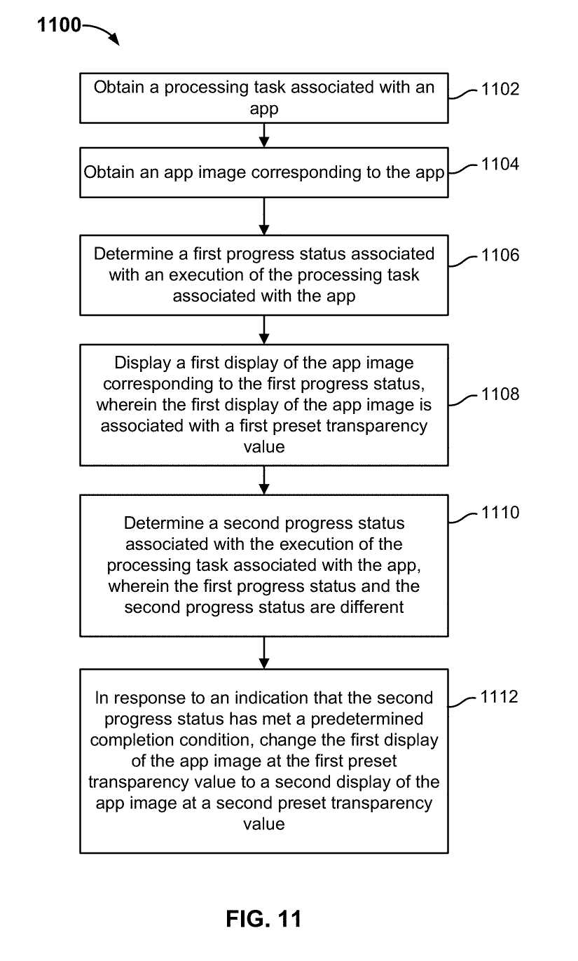

FIG. 11 is a flow diagram showing an embodiment of a process of displaying images associated with apps based on app processing task progress statuses. In some embodiments, process 1100 may be implemented at smart terminal 100 of FIG. 1, smart terminal 200 of FIG. 2, and/or operating system 300 of FIG. 3.

Process 1100 is similar to process 400 of FIG. 4 but includes an additional step of changing the transparency value with which the app image is displayed when the progress status of the execution of the processing task meets a certain predetermined completion condition.

At 1102, a processing task associated with an app is obtained. Step 1102 may be implemented similar to step 402 of process 400 of FIG. 4.

At 1104, an app image corresponding to the app is obtained. Step 1104 may be implemented similar to step 404 of process 400 of FIG. 4.

At 1106, a first progress status associated with an execution of the processing task associated with the app is determined. Step 1106 may be implemented similar to step 406 of process 400 of FIG. 4.

At 1108, a first display of the app image corresponding to the first progress status is displayed, wherein the first display of the app image is associated with a first preset transparency value.

At 1110, a second progress status associated with an execution of the processing task associated with the app is determined, wherein the first progress status and the second progress status are different. Step 1110 may be implemented similar to step 410 of process 400 of FIG. 4.

At 1112, in response to an indication that the second progress status has met a predetermined completion condition, the first display of the app image at the first transparency value is changed to a second display of the app image at a second preset transparency value.

In various embodiments, the predetermined completion condition is a condition that represents the completion of the execution of the processing task. If the progress task includes a percentage completion of the processing task, then the predetermined completion condition may be 100%, meaning that the processing task has completed.

In various embodiments, the app image is displayed using a “transparency value,” which determines how transparent or opaque the app image is to appear at a user interface. In various embodiments, prior to the progress status of the execution of the processing task meeting the predetermined completion condition (e.g., 100%), the app image is displayed using a first preset transparency value and after the progress status meets the predetermined completion condition, the app image is shown to be gradually displayed from using the first preset transparency value to using the second preset transparency value. The second preset transparency value causes the app image to appear more opaque than when it had been displayed using the first preset transparency value. For example, a transparency value may be in the range of [0, 1], where 1 indicates total transparency, and 0 indicates total non-transparency (i.e., complete opacity). For example, the second preset transparency value is set to 0, in which case the first preset transparency value could be a positive real number greater than 0 and less than or equal to 1 (e.g., 0.5). As a result, before the progress status meets the predetermined completion condition, a first instance of the app image is displayed in a manner that appears to be transparent and after the progress status meets the predetermined completion condition, a second instance of the app image is displayed in a manner that appears to be completely non-transparent (i.e., completely opaque). For example, changing the display of the first instance of the app image using the first preset transparency value to the second instance of the app image using the second preset transparency value may be shown as an animation in which the first instance of the app image gradually transforms (e.g., becomes less translucent and more opaque) into the second instance of the app image. In some embodiments, the second instance of the app image being displayed using the second preset transparency value may be the original app image while the first instance of the app image being displayed using the first preset transparency value is obtained by modifying the original app image. In some embodiments, the appearance of the second instance of the app image being displayed using the second preset transparency value indicates that the app image is available to be accessed by a user. Animating the gradual change of the app image from appearing more translucent to less translucent or not translucent at all would provide a smooth and gradual shift to the user that the app has become available. Embodiments of the present application impose no restrictions as to the particular first preset transparency value and second preset transparency value.

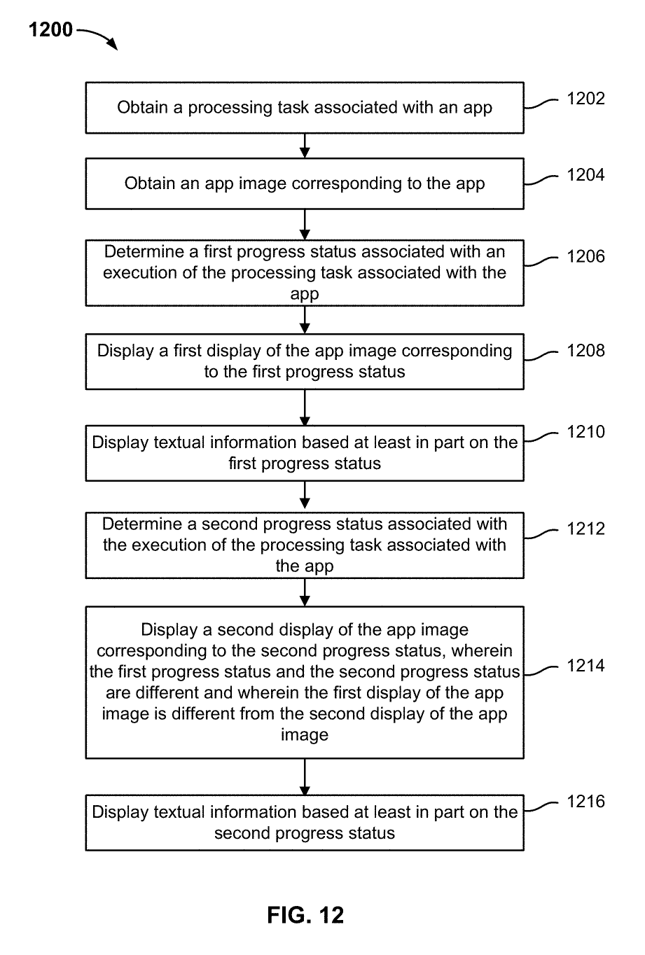

FIG. 12 is a flow diagram showing an embodiment of a process for displaying images associated with apps based on app processing task progress statuses. In some embodiments, process 1200 may be implemented at smart terminal 100 of FIG. 1, smart terminal 200 of FIG. 2, and/or operating system 300 of FIG. 3.

Process 1200 is similar to process 400 of FIG. 4 but includes an additional step of displaying textual information that is determined based on the progress status.

At 1202, a processing task associated with an app is obtained. Step 1202 may be implemented similar to step 402 of process 400 of FIG. 4.

At 1204, an app image corresponding to the app is obtained. Step 1204 may be implemented similar to step 404 of process 400 of FIG. 4.

At 1206, a first progress status associated with an execution of the processing task associated with the app is determined. Step 1206 may be implemented similar to step 406 of process 400 of FIG. 4.

At 1208, a first display of the app image corresponding to the first progress status is displayed. Step 1208 may be implemented similar to step 406 of process 400 of FIG. 4.

At 1210, textual information determined based at least in part on the first progress status is displayed.

At 1212, a second progress status associated with an execution of the processing task associated with the app is determined. Step 1212 may be implemented similar to step 410 of process 400 of FIG. 4.

At 1214, a second display of the app image corresponding to the second progress status is displayed, wherein the first progress status and the second progress status are different and wherein the first display of the app image is different from the second display of the app image. Step 1214 may be implemented similar to step 412 of process 400 of FIG. 4.

At 1216, textual information determined based at least in part on the second progress status is displayed.

In some embodiments, the textual information may comprise a percentage completion of the processing task that is indicated by the progress status. The textual information may be displayed near the app image to supplement the visual indication of the progress status of the processing task associated with the app. For example, the textual information may be displayed at the bottom of the target zone in which the app image (or a portion thereof) is displayed. In another example, the textual information may be displayed outside of the target zone in which the app image (or a portion thereof) is displayed. Embodiments of the present application impose no restrictions as to the specific location of the textual indicating information. Embodiments of the present application impose no restriction on the order in which steps 1208 and 1210 are executed or the order in which steps 1214 and 1216 are executed. Steps 1208 and 1210 may be implemented serially or at least partially in parallel. Steps 1214 and 1216 may be implemented serially or at least partially in parallel.

In some embodiments, the textual information may be displayed in a manner that becomes gradually less transparent as the progress status increases. Put another way, the textual information may “fade-in” as the progress status increases.

In some embodiments, when the progress status reaches a predetermined completion condition (e.g., the progress status reaches 100%, indicating that execution of the processing task has completed), the textual information that is displayed is replaced with the name of the app. In some embodiments, the displayed app image and the displayed app name serve as a shortcut for the app. In some embodiments, the textual information may be displayed in a manner that becomes gradually more transparent as the progress status increases and once the progress status reaches a predetermined completion condition (e.g., the progress status reaches 100%, indicating that execution of the processing task has completed), the textual information vanishes completely and is replaced with the name of the app. Put another way, the textual information may “fade-out” as the progress status increases.

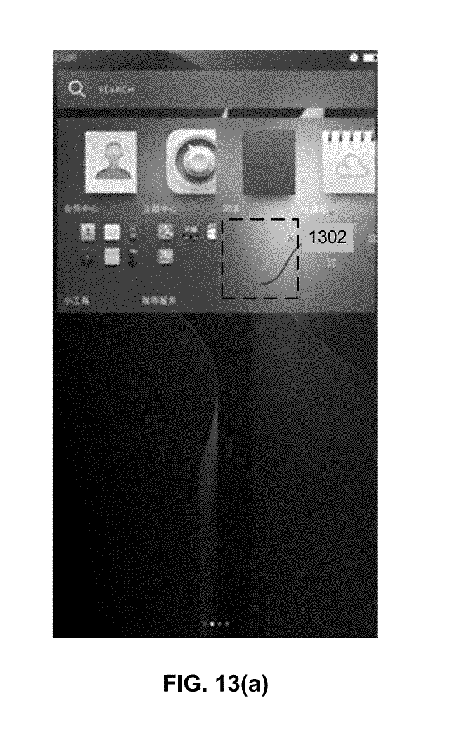

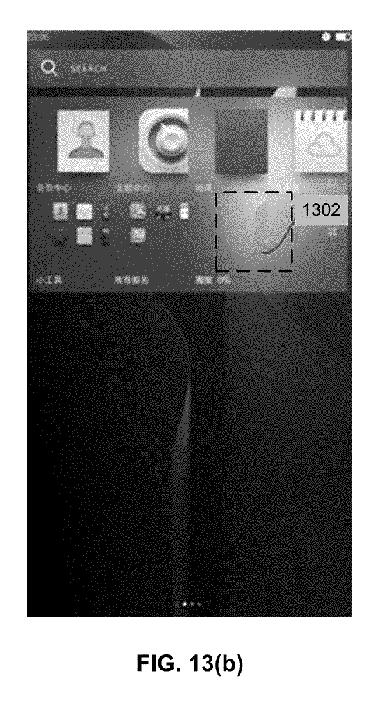

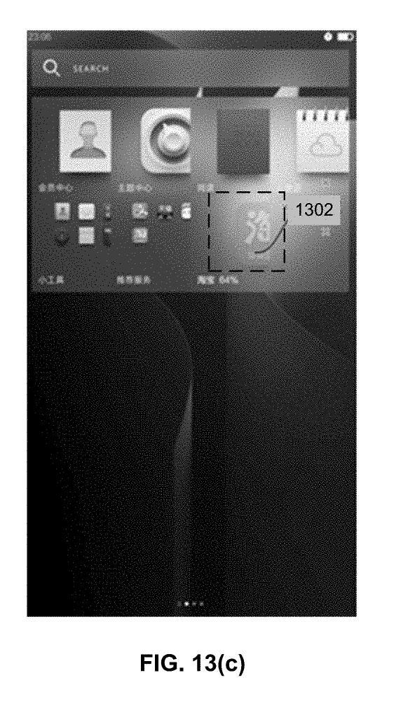

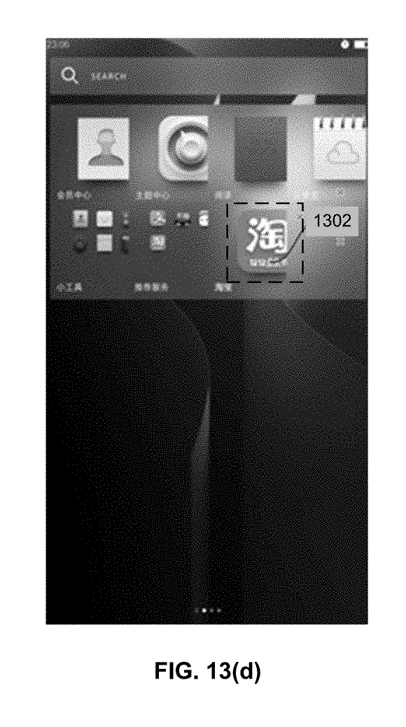

FIGS. 13(a), (b), (c), and (d) show example displays associated with displaying an app image in accordance with some embodiments. For example, FIGS. 13(a), (b), (c), and (d) may illustrate successive displays at a user interface (e.g., desktop) for processing tasks of downloading or installing an app. Back panel 1302, which is delineated by the dotted rectangle, is included in a target zone in which an app image for which a processing task is executed is to be displayed. In FIG. 13(a), back panel 1302 is initially empty, as the execution of the processing task has not yet begun. In FIG. 13(b), a portion of the app image appears in back panel 1302 and the app image is shown to be more transparent than the opacity of the original app image. FIG. 13(b) also shows a text that includes the current percentage of completion (the progress status) of the processing task (0%). In FIG. 13(c), a greater portion of the app image appears in back panel 1302 than had appeared in FIG. 13(b) and the app image is shown to be more transparent than the opacity of the original app image. FIG. 13(c) also shows a text that includes the current percentage of completion (the progress status) of the processing task (64%). The portions of the app image in FIGS. 13(b) and (c) are each shown to be displayed at a first preset transparency value. FIG. 13(d) shows that the processing task (e.g., the downloading) associated with the app has completed and that therefore, the app image is shown in its entirety, as well as at the second preset transparency value. Furthermore, in FIG. 13(d), the textual information that included the percentage completion of the processing task is now replaced with the name of the app.

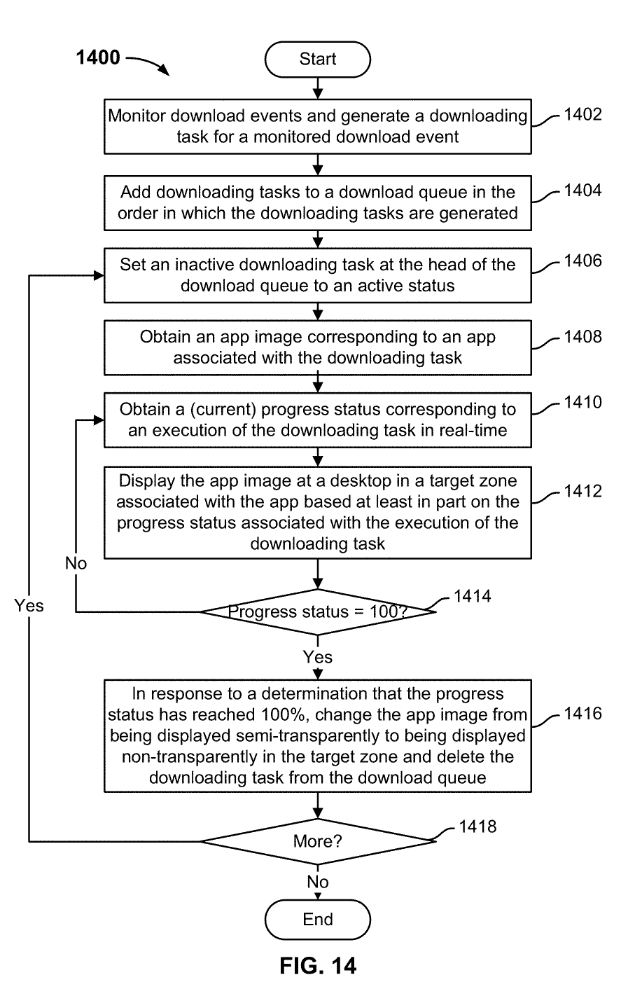

FIG. 14 is a flow diagram showing an example of a process for displaying images associated with apps based on app processing task progress statuses. In some embodiments, process 1400 may be implemented at smart terminal 100 of FIG. 1, smart terminal 200 of FIG. 2, and/or operating system 300 of FIG. 3.

Process 1400 describes an example process by which processing tasks corresponding to various apps are obtained and stored in a queue. The processing tasks are then fetched from the queue and executed at a smart terminal. The progress status of the execution of each processing task is then reflected by the manner which at least the app image corresponding to the app that is associated with the processing task is displayed at a user interface of the smart terminal.

At 1402, download events are monitored and a downloading task associated with an app is generated for a monitored download event. For example, after a user makes a user selection to download an app at an app management program (e.g., app center) of the smart terminal, that user selection is monitored by the desktop and the desktop can generate a corresponding app downloading task. For example, the downloading task may comprise: the name of the app or the name of the installation package corresponding to the app (“package name”), download address, and other such information.

At 1404, downloading tasks are added to a download queue in the order in which the downloading tasks are generated. The initial status of the newly added downloading task in the download queue is inactive.

At 1406, an inactive downloading task at the head of the download queue is set to an active status. The downloading task at the head of the queue may be the oldest task in the queue (if a FIFO scheme is used) and the active status is used to represent the fact that the downloading task is being processed.

The following may be performed for the downloading task for which the active status is set:

At 1408, an app image corresponding to an app associated with an execution of the downloading task is obtained. The first preset transparency value at which the app image is displayed at the user interface of the smart terminal causes the app image to be semi-transparent, for example.

At 1410, a (current) progress status corresponding to the downloading task is obtained in real-time.

At 1412, the app image is displayed at a desktop in a target zone associated with the app based at least in part on the progress status associated with the execution of the downloading task. In the target zone of the desktop, a fade-in effect is used in displaying textual information that is determined based on the progress status.

At 1414, it is determined whether the current progress status has reached 100%. In the event that the current progress status has reached 100%, meaning that the execution of the processing task has completed, control is transferred to 1416. Otherwise, in the event that the current progress status has not reached 100%, meaning that the execution of the processing task has not yet completed, control is returned to 1410.

As such, steps 1410 and 1412 may be repeated multiple times as the progress status changes dynamically and the app image may be displayed differently for each updated progress status. As the progress status changes (e.g., increases) over time, the displays of the app image at different times corresponding to different progress statuses may differ.

At 1416, in response to a determination that the progress status has reached 100%, the app image changes from being displayed semi-transparently to being displayed non-transparently in the target zone and the downloading task is deleted from the download queue. Moreover, a fade-out effect is used for displaying the textual indicating information near the app image such that the name of the app is displayed to replace the textual indicating information after the textual indicating information vanishes.

At this point, the execution of the downloading task is complete. The app image and name corresponding to the downloaded app appear on the desktop like the other already installed apps. By selecting the app image for which the downloading task has been completed, the app may launch/execute/run.

Furthermore, after the execution of the downloading task reaches 100%, the active status downloading task is deleted from the download queue.

At 1418, it is determined whether the download queue includes another inactive downloading task. If so, control is returned to 1406. Otherwise, process 1400 ends.

Each of the embodiments contained in this description is described in a progressive manner. The explanation of each embodiment focuses on areas of difference from the other embodiments, and the descriptions thereof may be mutually referenced for portions of each embodiment that are identical or similar.

An embodiment of the present application further provides non-volatile, readable storage media. These storage media store one or more modules (programs), and when these one or more modules are applied on a device, they cause the device to execute the instructions of each method step in embodiments of the present application.

An embodiment comprises one or more machine-readable media in which are stored instructions, which, when executed by one or more processors, cause a device to execute one or more methods as described for the server side.

An embodiment comprises one or more machine-readable media in which are stored instructions, which, when executed by one or more processors, cause a device to execute one or more methods as described for a smart terminal.

The embodiments of the present application are described with reference to flowcharts and/or block diagrams based on methods, terminal devices (systems), and computer program products of the embodiments of the present application. Please note that each flowchart and/or block diagram within the flowcharts and/or block diagrams and combinations of flowcharts and/or block diagrams within the flowcharts and/or block diagrams can be realized by computer commands. These computer program commands can be provided to the processors of general-purpose computers, specialized computers, embedded processor devices, or other programmable data-processing terminals to produce a machine. The commands executed by the processors of the computers or other programmable data-processing terminal devices consequently give rise to means for implementing the functions specified in one or more processes in the flowcharts and/or one or more blocks in the block diagrams.

These computer program commands can also be stored in computer-readable memory that can guide the computers or other programmable data-processing terminal equipment to operate in a specific manner. As a result, the commands stored in the computer-readable memory give rise to products including command devices. These command devices implement the functions specified in one or more processes in the flowcharts and/or one or more blocks in the block diagrams.

These computer program commands can also be loaded onto computers or other programmable data-processing terminal devices and made to execute a series of steps on the computers or other programmable data-processing terminal devices so as to give rise to computer-implemented processing. The commands executed on the computers or other programmable data-processing terminal devices thereby provide the steps of the functions specified in one or more processes in the flowcharts and/or one or more blocks in the block diagrams.

Although preferred embodiments of the present application have already been described, persons skilled in the art can make other modifications or revisions to these embodiments once they grasp the basic creative concept. Therefore, the attached claims are to be interpreted as including the preferred embodiments as well as all modifications and revisions falling within the scope of the embodiments of the present application.

Lastly, it must also be explained that, in this document, relational terms such as “first” or “second” are used only to differentiate between one entity or operation and another entity or operation, without necessitating or implying that there is any such actual relationship or sequence between these entities or operations. Moreover, the term “comprise” or “contain” or any of their variants are to be taken in their non-exclusive sense. Thus, processes, methods, things, or terminal devices that comprise a series of elements not only comprise those elements, but also comprise other elements that have not been explicitly listed or elements that are intrinsic to such processes, methods, things, or terminal devices. In the absence of further limitations, elements that are limited by the phrase “comprises a(n) . . . ” do not exclude the existence of additional identical elements in processes, methods, things, or terminal devices that comprise the elements.

Detailed introductions were provided above to a method for displaying, a means for displaying icons, a device, a storage medium, and an operating system provided by the present application. This document has applied specific examples to explain the principles and implementations of the present application. The above descriptions of the embodiments are only for the purpose of aiding the understanding of the methods and core concepts of the present application. A person with ordinary skill in the art will always be able to make modifications in keeping with the idea of the present application to specific embodiments and scopes of the application. The content of this specification should not be understood as limiting the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
obtaining a processing task associated with an application (app);
obtaining an app image corresponding to the app;
determining a first progress status associated with an execution of the processing task associated with the app;
displaying a first display of the app image corresponding to the first progress status;
determining a second progress status associated with the execution of the processing task associated with the app; and
displaying a second display of the app image corresponding to the second progress status, wherein the first progress status is different from the second progress status and wherein the first display of the app image is different from the second display of the app image.

2. The method of claim 1, wherein the processing task is obtained from a cache, the cache storing a sequence of processing tasks associated with the app and one or more other apps.

3. The method of claim 1, wherein displaying the first display of the app image corresponding to the first progress status comprises:
determining a portion of the app image corresponding to the app based at least in part on the first progress status associated with the processing task; and
displaying the app image at a user interface based at least in part on the determined portion of the app image.

4. The method of claim 1, wherein displaying the first display of the app image corresponding to the first progress status comprises:
determining a first portion of the app image corresponding to the app based at least in part on the first progress status associated with the processing task; and
displaying the app image at a user interface based at least in part on the determined first portion of the app image including displaying the determined first portion of the app image within a target zone of the user interface, wherein a second portion of the app image is hidden, wherein the second portion comprises the app image less the determined first portion.

5. The method of claim 1, wherein displaying the first display of the app image corresponding to the first progress status comprises:
determining a first portion of the app image corresponding to the app based at least in part on the first progress status associated with the processing task; and
displaying the app image at a user interface based at least in part on the determined first portion of the app image including displaying an animation of the determined first portion of the app image sliding within a target zone of the user interface, wherein a second portion of the app image is hidden, wherein the second portion comprises the app image less the determined first portion.

6. The method of claim 1, wherein displaying the first display of the app image corresponding to the first progress status comprises:
determining a current size associated with the app image based at least in part on the first progress status associated with the execution of the processing task; and
displaying the app image at a user interface based at least in part on the determined current size.

7. The method of claim 1, wherein displaying the first display of the app image corresponding to the first progress status comprises:
determining a current size associated with the app image based at least in part on the first progress status associated with the execution of the processing task; and
displaying the app image at a user interface based at least in part on the determined current size including displaying an animation of the app image expanding from an initial size to the determined current size.

8. The method of claim 1, wherein displaying the first display of the app image corresponding to the first progress status comprises:
determining an alteration associated with the app image based at least in part on the first progress status associated with the execution of the processing task; and
displaying the app image at a user interface based at least in part on the determined alteration.

9. The method of claim 1, wherein the first display of the app image is associated with a first preset transparency value and the method further comprising in response to an indication that the second progress status has met a predetermined completion condition, changing the first display of the app image at the first preset transparency value to the second display of the app image at a second preset transparency value.

10. The method of claim 1, further comprising displaying textual information determined based at least in part on the first progress status.

11. A computer program product, the computer program product comprising a non-transitory computer readable storage medium and comprising computer instructions for:
obtaining a processing task associated with an application (app);
obtaining an app image corresponding to the app;
determining a first progress status associated with an execution of the processing task associated with the app;
displaying a first display of the app image corresponding to the first progress status;
determining a second progress status associated with the execution of the processing task associated with the app; and
displaying a second display of the app image corresponding to the second progress status, wherein the first progress status is different from the second progress status and wherein the first display of the app image is different from the second display of the app image.

12. The computer program product of claim 11, wherein the processing task is obtained from a cache, the cache storing a sequence of processing tasks associated with the app and one or more other apps.

13. The computer program product of claim 11, wherein displaying the first display of the app image corresponding to the first progress status comprises:
determining a portion of the app image corresponding to the app based at least in part on the first progress status associated with the processing task; and
displaying the app image at a user interface based at least in part on the determined portion of the app image.

14. The computer program product of claim 11, wherein displaying the first display of the app image corresponding to the first progress status comprises:
determining a first portion of the app image corresponding to the app based at least in part on the first progress status associated with the processing task; and
displaying the app image at a user interface based at least in part on the determined first portion of the app image including displaying the determined first portion of the app image within a target zone of the user interface, wherein a second portion of the app image is hidden, wherein the second portion comprises the app image less the determined first portion.

15. The computer program product of claim 11, wherein displaying the first display of the app image corresponding to the first progress status comprises:
determining a first portion of the app image corresponding to the app based at least in part on the first progress status associated with the processing task; and
displaying the app image at a user interface based at least in part on the determined first portion of the app image including displaying an animation of the determined first portion of the app image sliding within a target zone of the user interface, wherein a second portion of the app image is hidden, wherein the second portion comprises the app image less the determined first portion.

16. The computer program product of claim 11, wherein displaying the first display of the app image corresponding to the first progress status comprises:
determining a current size associated with the app image based at least in part on the first progress status associated with the execution of the processing task; and
displaying the app image at a user interface based at least in part on the determined current size.

17. The computer program product of claim 11, wherein displaying the first display of the app image corresponding to the first progress status comprises:
determining a current size associated with the app image based at least in part on the first progress status associated with the execution of the processing task; and
displaying the app image at a user interface based at least in part on the determined current size including displaying an animation of the app image expanding from an initial size to the determined current size.

18. The computer program product of claim 11, wherein displaying the first display of the app image corresponding to the first progress status comprises:
determining an alteration associated with the app image based at least in part on the first progress status associated with the execution of the processing task; and
displaying the app image at a user interface based at least in part on the determined alteration.

19. The computer program product of claim 11, wherein the first display of the app image is associated with a first preset transparency value and the computer program product further comprises further computer instructions in response to an indication that the second progress status has met a predetermined completion condition, changing the first display of the app image at the first preset transparency value to the second display of the app image at a second preset transparency value.

20. A system, comprising:
a processor; and
a memory coupled with the processor, wherein the memory is configured to provide the processor with instructions which when executed cause the processor to:
obtain a processing task associated with an application (app);
obtain an app image corresponding to the app;
determine a first progress status associated with an execution of the processing task associated with the app;
display a first display of the app image corresponding to the first progress status;
determine a second progress status associated with the execution of the processing task associated with the app; and
display a second display of the app image corresponding to the second progress status, wherein the first progress status is different from the second progress status and wherein the first display of the app image is different from the second display of the app image.
